(19) United States
(12) Patent Application Publication
(10) Pub. No.: US 2012/0282044 A1
(43) Pub. Date: Nov. 8, 2012

(54) ROTARY CUTTING TOOL HAVING A CUTTING EDGE FORMED OF VEINED PCD

(76) Inventors: Vladimir Volokh, Maalot (IL); Leonid Sharivker, Naharia (IL)

(21) Appl. No.: 13/394,017

(22) PCT Filed: Aug. 16, 2010
(86) PCT No.: PCT/IL2010/000702

§ 371 Date: Jun. 22, 2012

(30) Foreign Application Priority Data
Sep. 3, 2009 (IL) 200742

(51) Int. Cl. B23C 5/10; B23P 15/34

(52) U.S. Cl. 407/53; 76/115

(57) ABSTRACT

A rotary cutting tool formed from a blank, the rotary cutting tool comprising at least one tooth having a root, a cutting edge formed of veined PCD, and a face disposed between the root and the cutting edge. The face, as viewed in a cross-section perpendicular to an axis of the cutting tool, includes a first curved surface proximate the cutting edge and a second curved surface proximate the root and the first curved surface. For each cutting edge, the blank is provided with a respective groove having a leading surface that corresponds in shape to the first curved surface of the respective tooth.

### FIELD OF THE INVENTION

The present invention relates to rotary cutting tools, more particularly to rotary cutting tools with veined polycrystalline diamond cutting edges and the process of manufacturing the same.

### BACKGROUND OF THE INVENTION

It is known in the art of cutting tools to employ cutting edges made of polycrystalline diamond (PCD) or cubic boron nitride (CBN), compacted and sintered to a tungsten carbide (TC) blank. For brevity, PCD and CBN or other diamond like materials will be defined herein below by the term PCD.

U.S. Pat. No. 5,070,748 to Packer, describes the process of forming such a rotary cutter by forming a rotary cutter blank of cemented tungsten carbide; forming at least a pair of longitudinally extending grooves in an outside surface of the blank; filling the grooves with diamond-like material; bonding the diamond-like material in the grooves in the rotary cutter blank at a sufficient heat and pressure to form polycrystalline diamond-like material; forming longitudinally extending flutes in the rotary cutter blank along a leading edge of the polycrystalline diamond-like material; and forming a cutting edge along a leading edge of the polycrystalline diamond-like material.

In order to minimize PCD removal during the last step of forming a cutting edge along the leading edge of the PCD material, a modified PCD rotary cutter is suggested in U.S. Pat. No. 5,115,697 to Rodriguez, describing a veined PCD cutter wherein the grooves formed in the blank are radially oriented substantially at an angle that conforms to the angle of concave flutes that are subsequently formed adjacent the grooves in the rotary cutter blank. The cutter blank is subsequently machined to form the flutes and a cutting edge along an angled leading edge formed by the sintered diamond material.

FIGS. 1 to 3 show different views of a standard prior art rotary cutter in the form of a helical teeth cylindrical endmill 10, normally provided with a tooth face 22 having positive radial rake angle.

FIG. 1 shows a front view of a standard cylindrical four flute endmill 10, with helical teeth 12 and straight shank 14. Line A-A represents a cutting plane perpendicular to the center axis of the endmill 10. FIGS. 2 to 11 depict an enlarged cross-sectional view of different veined PCD rotary cutters at different production stages all taken along same cutting plane represented by line A-A in FIG. 1.

Referring to FIG. 2, there is shown a PCD endmill 20 made with tooth face 22 in the form of a single concave curve extending without break from the tooth root 24 to the cutting edge 26. The PCD endmill 20 is produced in accordance with known methods such as described above in U.S. Pat. No. 5,115,697. The TC blank 28 (FIG. 3), corresponding to the PCD endmill 20 of FIG. 2, is formed with grooves 30, radially oriented at an angle that conforms to the angle of the concave tooth face 22 (FIG. 2). PCD veins are compacted and sintered in grooves 30, and the cutter blank is subsequently machined to form the flutes 32 and cutting edges 26 along the angled leading face formed by the sintered PCD veins. The finished cutter is shown in FIG. 2, with the exposed PCD layer 34.

A disadvantage of this tooth form is that there occurs extensive rubbing of the 20 chip against the tooth face, resulting in high power consumption, and undesired heating of the cutting tool. Another problem is that chips adhere to the tooth face and do not clear easily out of the space between the milling cutter teeth.

As a solution, with relation to rotary cutters made of solid TC or high speed steel (HSS), it is suggested in U.S. Pat. No. 7,393,160 to the present applicant, to improve the rake face geometry, by providing a rotary multi-tooth milling cutter, each tooth having a tooth face comprising at least two sections, the first section nearest the cutting edge having a convex form as viewed in a cross section perpendicular to the cutter axis. Alternatively, the milling cutter may be further provided with a concave chip-breaking section located between the first and second sections.

However, the above solution cannot be implemented directly to PCD cutting tools, as described earlier, since, following the flute grinding step which exposes the flat face of the PCD material, heavy PCD removal is still necessitated when forming the convex or combined convex-concave shape of the tooth face. By nature, PCD is hard to grind and additional electric discharge machining (EDM) is involved before final grinding of the cutting edge can take place. Furthermore, due to removal of PCD material, the resulting cutting edge will be considerably weakened.

Consequently a new approach is required to improve the energy and chip disposal properties of PCD cutting tools, as already implemented in solid HSS and TC tools, in particular for machining materials that are hard to cut such as composite plastics reinforced with fibers of glass, carbon, boron or Kevlar.

### SUMMARY OF THE INVENTION

It is thus one object of the present invention to provide a modified tooth face geometry for PCD rotary cutters. It is another object, to provide a corresponding production blank that facilitates minimal PCD removal.

These objects are achieved according to one aspect of the present invention by providing a rotary cutting tool, made of a blank, having at least one tooth comprising a root and a cutting edge, the cutting edge being formed of veined PCD, wherein:

the tooth face as viewed in a cross-section perpendicular to an axis of the cutting tool includes a first curved surface proximate the cutting edge, and a second curved surface proximate the tooth root and the first curved surface, and

for each cutting edge, the blank is provided with a respective groove, said groove having a leading surface that corresponds in shape to the first curved surface of the respective tooth.

In accordance with another aspect of the invention, there is provided a blank for forming such a cutting tool.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a front view of a standard prior art endmill;

FIG. 2 is an enlarged cross-sectional view taken along line A-A in FIG. 1, of a prior art PCD endmill;

FIG. 3 is a schematic sectional view of the endmill of FIG. 2, demonstrating a production step;

FIG. 4 is a cross-sectional view of an endmill made in accordance with a first embodiment of the present invention;

FIG. 5 is a schematic sectional view of the endmill of FIG. 4, demonstrating a production step;

FIG. 6 is a cross-sectional view of an endmill made in accordance with a second embodiment of the present invention;

FIG. 7 is a schematic sectional view of the endmill of FIG. 6, demonstrating a production step;

FIG. 8 is a cross-sectional view of an endmill made in accordance with a third embodiment of the present invention;

FIG. 9 is a schematic sectional view of the endmill of FIG. 8, demonstrating a production step;

FIG. 10 is a cross-sectional view of an endmill made in accordance with a fourth embodiment of the present invention; and

FIG. 11 is a schematic sectional view of the endmill of FIG. 10, demonstrating a production step.

### DETAILED DESCRIPTION OF EMBODIMENTS

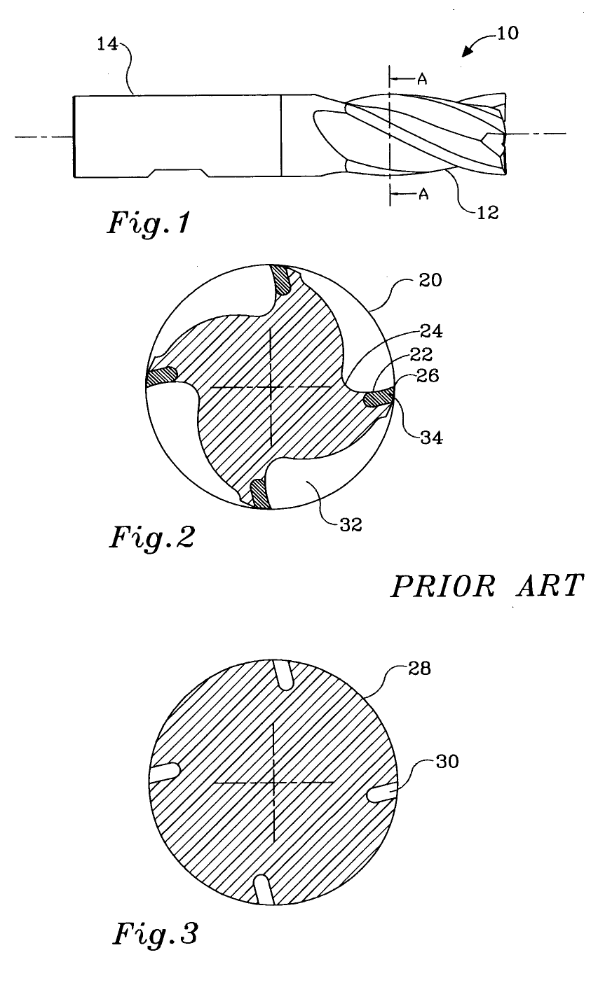

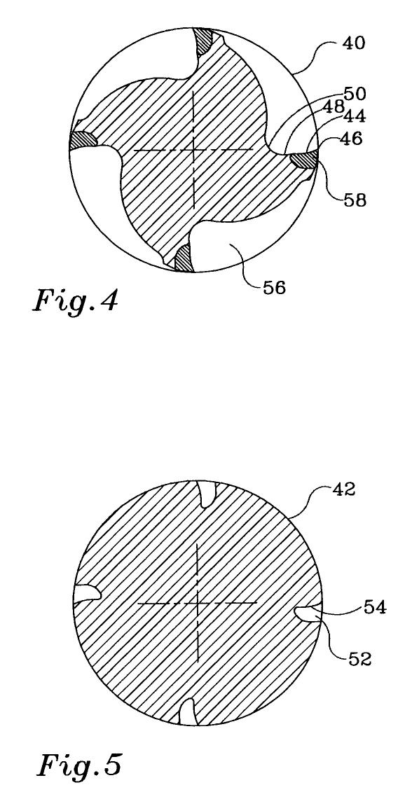

FIGS. 4 to 11 depict an enlarged cross-sectional view of a veined PCD rotary cutter according to the invention showing different production stages all taken along same cutting plane represented by line A-A in FIG. 1.

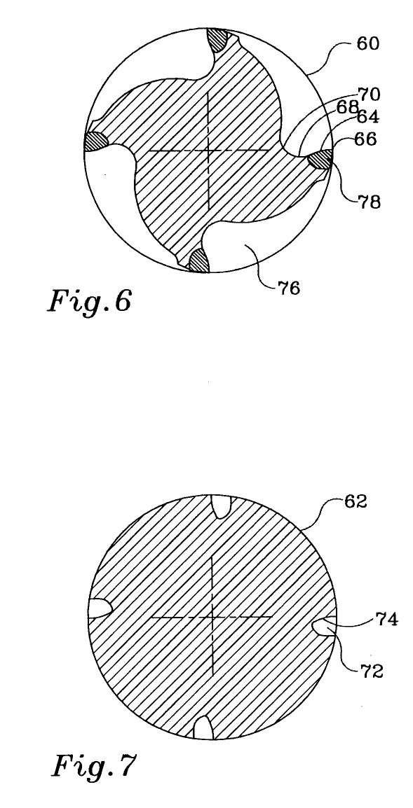

Referring to FIGS. 4 and 5, there are shown a four flute PCD rotary cutter 40 and corresponding blank 42 made in accordance with a first embodiment of the present invention. The tooth face, as viewed in a cross-section perpendicular to the cutter axis, is divided into two sections: a first concave section 44 (constituting a first curved surface) proximate the cutting edge 46, and a second concave section 48 (constituting a second curved surface) proximate the tooth root 50 and abutting the first section 44. The TC blank 42 is provided with grooves 52 formed with a leading face 54 corresponding to the shape of the first concave section 44 of the cutter 40. In some embodiments, the first concave section 44 is smaller than the second concave section 48.

Subsequent to compacting and sintering of PCD veins in grooves 52, the flutes 56 are formed by a standard grinding operation. The first concave section 44 of the PCD veins is exposed with close tolerance to final shape, and minimal EDM operation is required to remove residual traces of TC raw material before final grinding of the cutting edge 46 is performed. Full thickness and strength of the PCD layer 58 is maintained.

During operation of the cutting tool, workpiece chips are evacuated by the first concave section 44 and cleared away from the second concave section 48, thus significantly reducing adhesion of chips to the cutter and excessive heat.

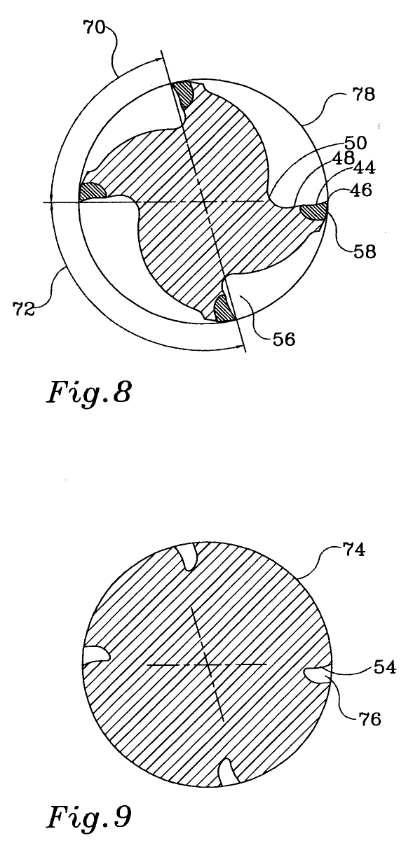

With reference to FIGS. 6 and 7, there is shown a four flute PCD rotary cutter 60 and corresponding TC blank 62 made in accordance with a second embodiment of the present invention. The tooth face, as viewed in cross-section perpendicular to the cutter axis, is divided into two sections, a first convex section 64 (constituting a first curved surface) proximate the cutting edge 66, and a second concave section 68 (constituting a second curved surface) proximate the tooth root 70 and abutting the first section 44. The blank 62 is provided with grooves 72 formed with leading face 74 corresponding to the final convex shape of the first convex section 64 of the cutter 60. In some embodiments, the first convex section 64 is smaller than the second concave section 68.

Subsequent to compacting and sintering of PCD veins in grooves 72, the flutes 76 are formed by a standard grinding operation. The first convex section 64 of the PCD veins is exposed with close tolerance to final shape, and minimal EDM operation is required to remove residual traces of TC raw material before final grinding of the cutting edge 66 is performed. Full thickness and strength of the PCD layer 78 is maintained.

During operation of the cutting tool, workpiece chips are evacuated by the first convex section 64 and cleared away from the second concave section 68, thus significantly reducing adhesion of chips to the cutter and excessive heat.

Choosing between rotary cutters made according to the first or second embodiments of the present invention is determined by several factors including the workpiece material, cutting speeds, availability of coolant and other working conditions familiar to the person skilled in the art.

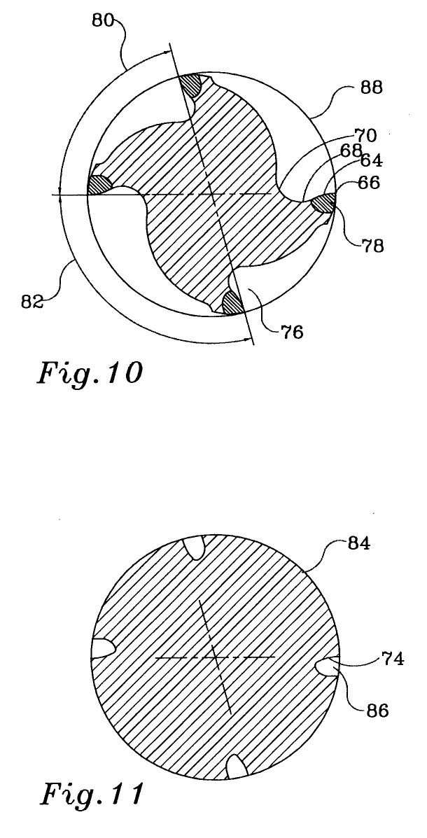

In a third embodiment of the present invention, as shown in FIGS. 8 and 9, the tooth face is identical in shape to the tooth face of the first embodiment of the present invention and the same reference numerals are used in relation to tooth shape. However, uneven flute spacing on the cutter perimeter, shown by the different angles 70, 72 included between adjacent cutting edges, provides better balance and less chatter. This uneven spacing prevents regular flute impacts from creating harmonic vibration. The blank 74 is provided with grooves 76 formed with the same uneven spacing corresponding to the flute spacing of the final cutter 78.

In a fourth embodiment of the present invention, as shown in FIGS. 10 and 11, the tooth face is identical in shape to the tooth face of the second embodiment and the same reference numerals are used in relation to tooth shape. Here again, uneven flute spacing on the cutter perimeter shown by the different angles 80, 82 included between adjacent cutting edges, provides better balance and less chatter. This uneven spacing prevents regular flute impacts from creating harmonic vibration. The blank 84 is provided with grooves 86 formed with the same uneven spacing corresponding to the flute spacing of the final cutter 88.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Thus, while the invention has been described with reference to a four flute cylindrical endmill, the same principles are applicable to other rotary cutters with one, two, three, five or any number of flutes evenly or unevenly spaced on the perimeter circle, as well as other cutter shapes such as disk, conical or spherical, all of which fall within the scope of the claims.

1-10. (canceled)

11. A rotary cutting tool formed from a blank, the rotary cutting tool comprising at least one tooth having a root, a cutting edge, and a face therebetween, the cutting edge being formed of veined PCD, wherein:
the face, as viewed in a cross-section perpendicular to an axis of the cutting tool, includes a first curved surface proximate the cutting edge and a second curved surface proximate the root and the first curved surface, and
for each cutting edge, the blank is provided with a respective groove having a leading surface that corresponds in shape to the first curved surface of the respective tooth.

12. The cutting tool of claim 11, wherein the first curved surface is concave and the second curved surface is concave.

13. The cutting tool of claim 11, wherein the first curved surface is convex in shape and said second curved surface is concave in shape.

14. The cutting tool of claim 11, wherein the first curved surface is of smaller width than the second curved surface.

15. The cutting tool of claim 11, further comprising a plurality of cutting edges evenly spaced apart on a perimeter circle of the cutting tool, wherein the blank includes an equal plurality of grooves such that a mutual separation between adjacent grooves corresponds to a flute spacing of the cutting tool.

16. The cutting tool of claim 11, further comprising a plurality of cutting edges unevenly spaced apart on a perimeter circle of the cutting tool, the blank includes an equal plurality of grooves such that a mutual separation between adjacent grooves corresponds to a flute spacing of the cutting tool.

17. The cutting tool of claim 11, wherein the cutting tool has an outer shape selected from the group consisting of: cylindrical, conical and spherical.

18. The cutting tool of claim 11, wherein the blank is formed of tungsten carbide.

18. A blank for forming a rotary cutting tool comprising at least one tooth having a root, a cutting edge formed of a veined PCD, and a face disposed between therebetween the root and the cutting edge, the face, as viewed in a cross-section perpendicular to an axis of the cutting tool, having a first curved surface proximate the cutting edge and a second curved surface proximate the root and the first curved surface, the blank comprising:
for each cutting edge, a respective groove having a leading surface that corresponds in shape to the first curved surface of the respective tooth.

19. The blank of claim 18, wherein the first curved surface is concave in shape.

20. The blank of claim 18, wherein the first curved surface is convex in shape.

21. The blank of claim 18, wherein the rotary cutting tool further comprises a plurality of cutting edges evenly spaced apart on a perimeter circle of the cutting tool, and wherein the blank comprises an equal plurality of grooves such that a mutual separation between adjacent grooves corresponds to a flute spacing of the cutting tool.

22. The blank of claim 18, wherein the rotary cutting tool further comprises a plurality of cutting edges unevenly spaced apart on a perimeter circle of the cutting tool, and wherein the blank includes an equal plurality of grooves such that a mutual separation between adjacent grooves corresponds to a flute spacing of the cutting tool.

23. The blank of claim 18, wherein the blank is formed of tungsten carbide.
